(19) United States
(12) Patent Application Publication
(10) Pub. No.: US 2024/0262456 A1
(43) Pub. Date: Aug. 8, 2024

(54) Method for Operating a Drive System of an Electric Bike

(71) Applicant: Robert Bosch GmbH, Stuttgart (DE)

(72) Inventors: Claus Fleischer, Stuttgart-Vaihingen (DE); Daniel Baumgaertner, Neustetten (DE)

(21) Appl. No.: 18/418,919

(22) Filed: Jan. 22, 2024

(30) Foreign Application Priority Data
Feb. 2, 2023 (DE) 10 2023 200 855.6

(51) Int. Cl. B62M 6/45; B62M 25/08

(52) U.S. Cl. CPC B62M 6/45; B62M 25/08

(57) ABSTRACT

A method for operating a drive system of an electric bike includes (i) increasing a motor torque generated by way of a motor of the electric bike for a predetermined first time interval, (ii) reducing the motor torque immediately after the first time interval for a predetermined second time interval, and (iii) changing a transmission ratio of a gearshift system of the drive system during the second time interval.

This application claims priority under 35 U.S.C. § 119 to patent application no. DE 10 2023 200 855.6, filed on Feb. 2, 2023 in Germany, the disclosure of which is incorporated herein by reference in its entirety.

### BACKGROUND

The present disclosure relates to a method for operating a drive system of an electric bike, and to an electric bike.

Drive systems with gearshift systems for bicycles comprising derailleur gears are known. In this context, a transmission ratio in the drive system is changed by moving a bike chain between sprockets of different sizes. Conventionally, shifting under load is difficult or impossible in this case due to the design or leads to increased wear. Automatic gearshifts are also known in which, e.g., the shifting process is initiated at suitable rider torques or at certain crank positions.

### SUMMARY

In contrast, the method according to the disclosure offers the advantage that shifting can be performed at any time and with low wear. In particular, shifting gears on electric bikes is in this case enabled such that there is little or no loss of speed during the shifting process. According to the disclosure, this is achieved by a method for operating a drive system of an electric bike, comprising the following steps:
increasing a motor torque generated by a motor of the electric bike for the duration of a predetermined first time interval,
reducing the motor torque immediately after the first time interval for the duration of a predetermined second time interval, and
changing a transmission ratio of a gearshift system of the drive system during the second time interval.

In particular, the increase in motor torque and the reduction in motor torque are in this case actively controlled in a targeted manner.

Changing the transmission ratio can be regarded in particular as a shifting process or “shifting”.

In other words, the method involves shifting during an active reduction of the motor torque generated by the motor. Said reduction in this case takes place immediately after a previous, particularly brief, active increase in motor torque. By increasing the motor torque, an electric bike rider briefly loses traction on the chain, thereby reducing the rider's torque acting on the gearshift system. The immediately subsequent reduction of the motor torque ensures that the total torque, which is the sum of the motor torque and the rider's torque, is reduced during the second time interval, thereby enabling the transmission ratio to be changed, i.e. shifting, with a particularly low total torque acting on the gearshift system. As a result, an optimal, in particular fast and wear-free shifting process, is enabled. In addition, the prior increase in motor torque means that there is little or no loss of speed during the entire shifting process.

Preferred embodiments of the disclosure are also set forth below.

Preferably, the motor torque is increased such that the motor torque is increased from a first motor torque to a boost motor torque. The boost motor torque corresponds in this case to at least 120%, preferably at least 140%, particularly preferably a maximum of 500% of the first motor torque. In particular, the first motor torque in this case corresponds to a motor torque that is generated during the normal riding mode of the electric bike based on the pedaling force or rider's torque of the rider. As a result, the boost motor torque provided by the motor is significantly increased shortly before the shifting process as a result, so the effect of the rider briefly losing traction on the chain and thus the total torque being as low as possible or equal to zero during the second time interval is particularly reliable.

It is particularly preferable to reduce the motor torque such that the motor torque is reduced to a shifting motor torque. The shifting motor torque is in this case smaller than the first motor torque, which is generated before the first time interval. In other words, during the second time interval, the motor torque is actively reduced under control to such an extent that the shifting motor torque generated during the second time interval is less than the motor torque that was present before the first time interval was increased. A particularly reliable low motor torque is ensured thereby and, in particular, a low total torque is also present in the gearshift system during the shifting process.

In particular, the shifting motor torque is zero. Alternatively, the shifting motor torque is preferably a maximum of 20%, preferably a maximum of 10%, of the first motor torque, or alternatively a maximum motor torque. Maximum motor torque is considered to be the maximum motor torque that can be provided by the motor in a normal operating mode. In other words, the shifting motor torque is reduced to a particularly low value in order to enable a particularly reliable, low-wear, and time-efficient shifting process.

Further preferably, the method further comprises the following step: a second increase of the motor torque, in particular immediately, after the second time interval. In other words, after the second time interval has elapsed, the motor torque is increased again based on the shifting motor torque. As a result, the rider is able to apply traction to the chain again immediately after the shifting process and also enables the motor to start up again, ensuring that the electric bike's propulsion is interrupted as little or as briefly as possible.

Preferably, the second increase in motor torque takes place for a predetermined third time interval. The motor torque is in this case increased to a value that is greater than the first motor torque before the first time interval. In particular, a second boost takes place after the shifting process. Preferably, the motor torque is increased to the boost motor torque in the third time interval. As a result, the bike is able to to be propelled particularly reliably without significant interruptions.

Preferably, the first time interval is adapted depending on the ascertained riding parameters and/or environmental parameters. In other words, the first time interval can be extended or shortened adaptively depending on the current riding parameters and/or environmental parameters. As a result, the effect of the boost is able to be achieved particularly effectively.

Preferably, the increase in motor torque during the first time interval is adapted depending on the ascertained riding parameters and/or environmental parameters. In other words, depending on the current riding parameters and/or environmental parameters, the boost motor torque can be increased or reduced adaptively or a gradient of the increase in motor torque can be adjusted within the first time interval. As a result, the boost effect can be achieved particularly reliably depending on the situation.

Particularly preferably, the riding parameters and/or environmental parameters comprise at least one of the following parameters: instantaneous gradient, instantaneous acceleration, instantaneous or imminent rider's torque, instantaneous cadence, road characteristics, road course, navigation data. In particular, the parameters can be recorded using sensors. For example, a control unit can also be used to estimate the upcoming rider's torque, for example by interpolating the current rider's torque. The road characteristics can, e.g., be used to ascertain whether the electric bike is currently traveling on a road or off-road. Curves in particular can be taken into account as the course of the road. In other words, the effect of the boost can be designed particularly effectively and reliably depending on the current riding mode.

Further preferably, the method further comprises the following step: output of an acoustic and/or visual indication of the imminent increase in motor torque, preferably by means of an output device of the electric bike. In other words, the rider of the electric bike can be warned that a gear shifting is about to take place during which the boost will be used. A high level of riding comfort for the rider is enabled thereby.

Preferably, the method is performed exclusively during pedal actuation by a rider of the electric bike. In other words, only when the rider uses muscle power to generate rider's torque is the shifting performed by means of boost and the subsequent reduction of the motor torque following the boost.

It is particularly preferable to change the transmission ratio of the gearshift system by means of a controllable actuator. In particular, an electric motor can be regarded as an actuator, which is therefore preferably an electronic shifting means. A particularly high level of user comfort and simple and flexible implementation of the method is enabled thereby. In particular, shifting and increasing or reducing the motor torque can be precisely coordinated.

The actuator is also preferably operated automatically by means of a control unit. In particular, shifting is therefore fully automatic, in particular initiated exclusively by the control unit. Alternatively or additionally, the actuator is actuated in response to a manually generated shifting signal. The shifting signal can, e.g., be generated by a rider of the electric bike using an input device, e.g. by pressing a button. The shifting signal can, e.g., be used to actuate the actuator directly or, alternatively, indirectly via the control unit. For example, an upshift or downshift command can be generated as a shifting signal. As a result, it is particularly easy and convenient for the rider of the electric bike to operate and ride.

Preferably, the method further comprises the following steps: recording and comparing shifting durations of the gearshift system, in particular during the second time interval, and ascertaining a functionality of the gearshift system based on the comparison of the shifting durations. In particular, wear and/or a shifting setting is ascertained or verified as a functional capability. Preferably, the shifting duration is considered to be the time required to change the transmission ratio. Due to increased wear or, e.g., incorrect or unfavorable adjustment of the rear derailleur, said shifting duration in this case increases with the service life. The recording can in this case be used to ascertain the presence of increased wear or, e.g., a malfunction. For example, the need for maintenance can be ascertained on this basis.

Furthermore, the disclosure leads to an electric bike comprising a drive system with a gearshift system, a motor and a control unit. The control unit is configured to operate the gearshift system. The control unit is further configured to perform the described method.

The motor is preferably configured to generate a predetermined maximum motor torque in normal riding mode. In particular, the maximum motor torque available to support the rider's pedaling force is regarded as the maximum motor torque. The increased boost motor torque generated during the first time interval corresponds in this case to at least 120%, preferably a maximum of 150%, of the maximum motor torque. In other words, the motor is designed such that there is always a reserve available for the boost motor torque, so that the motor torque can still be increased to the boost motor torque even during riding mode with maximum assistance.

In other words, optimized shifting can be performed reliably at any time.

### BRIEF DESCRIPTION OF THE DRAWINGS

The disclosure is described in the following with reference to exemplary embodiments in conjunction with the drawings. In the drawings, functionally identical components are identified with respectively identical reference characters. Shown are:

FIG. 1 a simplified schematic view of an electric bike with a gearshift system in which a method according to a preferred exemplary embodiment of the disclosure is performed, and

FIG. 2 a simplified schematic view of torque curves when performing the method of the preferred exemplary embodiment.

### DETAILED DESCRIPTION

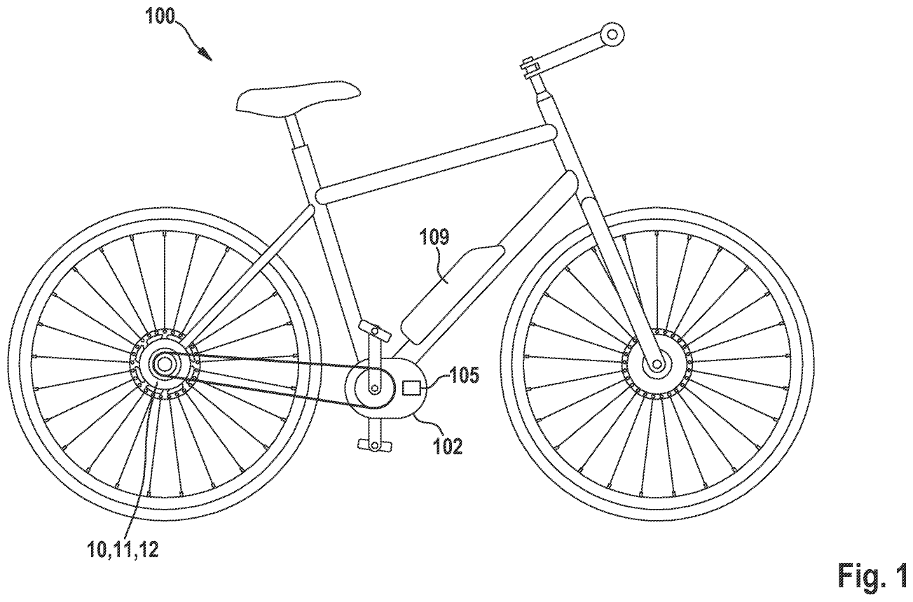

FIG. 1 shows a simplified schematic view of an electric bike 100 comprising a drive system 10. The drive system 10 comprises a drive unit in the area of the bottom bracket, which comprises a motor 102, which is in particular an electric motor. The motor 102 can be supplied with electrical energy by means of an electrical energy storage unit 109 of the electric bike 100.

A motor torque generated by the motor 102 can be used to provide motor support for a pedaling force generated by the muscle power of a rider of the electric bike 100.

The drive system also comprises a gearshift system 12. The gearshift system 12 is only shown schematically in a very simplified form in FIG. 1. In particular, the gearshift system 12 comprises at least one shifting by means of which a transmission ratio in the drive system 10 of the electric bike 100 can be changed. For example, the shifting means can be provided as derailleur gears on a rear wheel hub and/or on chainrings, whereby different transmission ratios can be provided in particular by means of different sized sprockets. Alternatively, other types of shifting means, e.g. gearboxes or hub gears, can also be provided.

The gearshift system 12 in this case comprises an actuator 11, which is configured to actuate the shifting means, i.e. to initiate the gear change, e.g. by moving a rear derailleur. In particular, the actuator 11 comprises an electric motor, so that the gearshift system 10 is preferably an electronic shifting means.

The electric bike 100 also comprises a control unit 105, which is configured to actuate the actuator 11 and the motor 102. The control unit 105 is in this case also designed to perform the method according to the preferred exemplary embodiment.

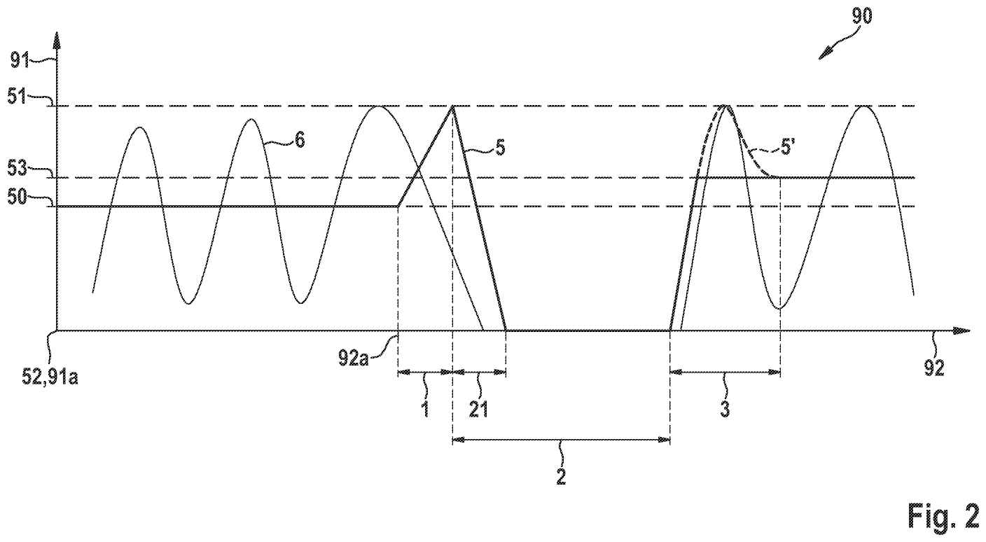

The method is explained in detail hereinafter with reference to FIG. 2. FIG. 2 shows a graph 90 with torque curves that occur during the method. A torque 91 is in this case shown over time 92. Reference character 91a indicates a torque with the value zero.

FIG. 2 shows a single shifting process in detail, i.e., a one-off change to a transmission ratio of the gearshift system 12.

In this case, FIG. 2 shows exemplary curves for a motor torque 5, which is generated by the motor 102, and a rider's torque 6, which is generated by the rider using muscle power when pedaling. As can be seen in FIG. 2, the rider's torque 6 occurring at the crankshaft is in this case essentially periodically fluctuating, e.g. sinusoidal.

The motor torque 5 generated by the motor 102 is generated depending on the rider's torque 6, e.g. depending on an average value of the rider torque 6.

A shifting signal is generated at time 92a. The shifting signal can either be generated automatically by the control unit 105, or alternatively in response to a shift request generated manually by the rider of the electric bike 100, which can, e.g., be generated by means of an input unit. Automatic shifting by means of the control unit 105 can, e.g., be achieved by monitoring riding parameters such as, in particular, cadence, speed, and the like.

In the method, the motor torque 5 is increased for a predetermined first time interval 1 immediately after the shifting signal is generated. During the first time interval 1, the motor torque 5 is in this case increased linearly from a first motor torque 50, which is present before the shifting signal, to a boost motor torque 51. The boost motor torque 51 is preferably at least 120% of the first motor torque 50.

The first time interval 1 can in this case have, e.g., a predetermined duration of at least 0.2 seconds, preferably a maximum of 1 second, preferably 0.5 seconds.

It is particularly advantageous if the first time interval 1 is adaptively adjustable. In particular, an adaptation to current riding parameters and/or environmental parameters, e.g., in particular a current gradient, a current acceleration, a current or imminent rider's torque, a current cadence, road characteristics, a road course, and/or navigation data can be performed thereby.

Immediately after the first time interval 1, the motor torque 5 is reduced for a predetermined second time interval 2. The motor torque 5 is in this case reduced to a predetermined shifting motor torque 52, which has the value zero in the exemplary embodiment shown. Preferably, the motor torque 5 is in this case reduced linearly to zero within a partial time interval 21 of the second time interval 2. During the remainder of the second time interval 2, the motor torque 5 is preferably kept at zero.

The second time interval 2 and/or the partial time interval 21 can also have a predetermined duration, for example of at least 0.2 seconds, preferably a maximum of 2 seconds. For example, the second time interval 2 and/or the partial time interval can also be adaptively adjustable to one or more riding parameters and/or environmental parameters.

The transmission ratio of the gearshift system 10 is in this case changed during the second time interval 2, i.e., the shifting takes place within the second time interval 2.

The special increase of the motor torque 5 to the boost motor torque 51 and the subsequent reduction to the shifting motor torque 52 thereby offers the advantage that the rider loses traction on the chain due to the brief acceleration of the electric bike 100 and the subsequent reduction of the motor torque 5. In other words, the rider torque 6 acting on the gearshift system 10 is also reduced to zero, as can be seen in FIG. 2. As a result, the total torque on the gearshift system 10 is as low as possible, particularly after the partial time interval 21. In the exemplary embodiment shown, this total torque is zero. As a result, shifting within the second time interval 2 can be performed in a particularly simple and time-efficient manner and with low wear.

Immediately after the second time interval 2, the motor torque 5 is increased again. Preferably, the motor torque 5 can in this case be increased directly to a corresponding target motor torque 53, which is provided in normal riding mode of the electric bike 100 depending on the rider's torque 6.

Alternatively, as indicated by the dashed line 5′, the motor torque 5 can be increased again briefly to the value of the boost motor torque 51 within a third time interval 3. Particularly advantageously, it is thereby possible to minimize the loss of speed caused by shifting because the increased motor torque 5 forces the electric bike 100 to accelerate more quickly for a short period. A particularly high level of riding comfort is provided thereby because the rider can tension the chain more quickly.

What is claimed is:

1. A method for operating a drive system of an electric bike, comprising:
increasing a motor torque generated by a motor of the electric bike for a predetermined first time interval;
reducing the motor torque immediately after the first time interval for a predetermined second time interval; and
changing a transmission ratio of a gearshift system of the drive system during the second time interval.

2. The method according to claim 1, wherein:
the increasing of the motor torque is performed such that the motor torque is increased from a first motor torque to a boost motor torque, and
the boost motor torque corresponds to at least 120% of the first motor torque.

3. The method according to claim 1, wherein:
the reducing of the motor torque is performed such that the motor torque is reduced to a shifting motor torque, and
the shifting motor torque is smaller than the first motor torque before the first time interval.

4. The method according to claim 3, wherein the shifting motor torque is zero, or wherein the shifting motor torque corresponds to a maximum of 20% of the first motor torque or a maximum motor torque.

5. The method according to claim 1, further comprising the following step: a second increase of the motor torque after the second time interval.

6. The method according to claim 5, wherein the second increase of the motor torque for a predetermined third time interval is performed based on a value which is greater than the first motor torque before the first time interval.

7. The method according to claim 1, wherein the first time interval is adapted depending on ascertained riding parameters and/or environmental parameters.

8. The method according to claim 1, wherein the increase of the motor torque during the first time interval is adapted depending on riding parameters and/or environmental parameters.

9. The method according to claim 7, wherein the riding parameters and/or environmental parameters comprise at least one of: instantaneous gradient, instantaneous acceleration, instantaneous or impending rider's torque, instantaneous cadence, road characteristics, road course, and navigation data.

10. The method according to claim 1, further comprising outputting an audible and/or visual indication of an imminent increase in motor torque.

11. The method according to claim 1, wherein the changing of the transmission ratio of the gearshift system is performed by way of a controllably operable actuator.

12. The method according to claim 11, wherein:
the actuator is actuated automatically by way of a control unit, and/or
the actuator is actuated in response to a manually generated shifting signal.

13. The method according to claim 1, further comprising:
recording and comparing shifting durations of the gearshift, and
ascertaining the functionality of the gearshift system based on the comparison of the shifting durations.

14. An electric bike, comprising:
a drive system having a gearshift system;
a motor; and
a control unit configured to actuate the gearshift system,
wherein the control unit is further configured to perform the method according to claim 1.

15. The electric bike according to claim 14, wherein the motor is configured to generate a predetermined maximum motor torque in a normal riding mode, and wherein the increased boost motor torque during the first time interval corresponds to at least 120% of the maximum motor torque.

16. The method according to claim 2, wherein the boost motor torque corresponds to at least 140% of the first motor torque.

17. The method according to claim 3, wherein the shifting motor torque is zero, or wherein the shifting motor torque corresponds to a maximum of 10% of the first motor torque or a maximum motor torque.

18. The method according to claim 1, further comprising:
recording and comparing shifting durations of the gearshift system during the second time interval, and
ascertaining the functionality of the gearshift system, including wear and/or a shifting setting, based on the comparison of the shifting durations.

19. The electric bike according to claim 14, wherein the motor is configured to generate a predetermined maximum motor torque in a normal riding mode, and wherein the increased boost motor torque during the first time interval corresponds to at least 150% of the maximum motor torque.
